(19) United States
(12) Patent Application Publication
(10) Pub. No.: US 2008/0056666 A1
(43) Pub. Date: Mar. 6, 2008

(54) RECEIVER AND INFORMATION PROCESSING METHOD

(76) Inventor: Satoshi Mio, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/828,385

(22) Filed: Jul. 26, 2007

(30) Foreign Application Priority Data
Sep. 4, 2006 (JP) 2006-238444

(51) Int. Cl. H04N 5/91

(52) U.S. Cl. 386/65; 386/E05.003

(57) ABSTRACT

An object of this invention is to provide a receiver that downloads a transport stream at a bit rate different from the normal playback rate, attaches to the transport stream timestamps representing a playback timing for playback at the normal rate and then stores the time-stamped stream. When the receiver receives the transport stream at a transmission rate different from the normal playback rate and stores the stream, the receiver calculates timestamps representing a playback timing for playback at the normal rate according to the speed ratio of the received transport stream and attaches the timestamps to the transport stream before storing it as a time-stamped transport stream.

### INCORPORATION BY REFERENCE

The present application claims priority from Japanese application JP2006-238444 filed on Sep. 4, 2006, the content of which is hereby incorporated by reference into this application.

### BACKGROUND OF THE INVENTION

The present invention relates to a receiver and an information processing method which use digital content data such as videos and audios.

Satellite and terrestrial digital broadcasting has come into widespread use in recent years and data broadcasting is also being used. Also, a data transmission service, so-called streaming, of digital content such as videos and audios has come to be used through wideband communication networks currently available to home.

In these services, content such as videos and audios is compressed with MPEG system and transmitted in real time in the form of MPEG transport stream. A receiver checks a PCR packet, that is periodically inserted in the transport stream and has time information representing a playback timing, to adjust an oscillation frequency of a decoder clock and thereby realize a playback synchronized with the sending side.

The receiver has a storage function. When a transport stream is received in real time and later played back, each packet of the transport stream is attached with a timestamp representing a playback timing before being stored. During playback the packets are read out from a storage and, according to the timestamps, are sent to a decoder for playback at a correct transmission rate.

JP-A-2002-16561 describes an example system that transmits content data at a transmission rate different from that of the normal playback rate by using a broadcasting technique and then stores the data in the receiver for later use.

In this example system, a transport stream that has been broadcast at a transmission rate different from the normal playback rate is received and the packets of the transport stream are each attached with a timestamp representing a timing during normal playback rate before being stored as a time-stamped transport stream.

### SUMMARY OF THE INVENTION

However, the system of JP-A-2002-16561 requires adding to the transport stream the packets of proprietary specifications that contains data indicating a ratio of the transmission rate, as from broadcasting stations, to the normal playback rate. The modifications on the sending side in turn require the receiving side to conform to the modified system, making the entire system complicated and giving rise to a possibility of cost increase.

Modifying the processing on the sending side as in JP-A-2002-16561 makes the system costly and complicated in terms of facility and configuration. It is therefore desirable to leave the processing on the sending side as is and to perform appropriate processing on the receiving side if data is transmitted at a rate different from the normal playback rate.

Although JP-A-2002-16561 focuses on modifying the transport stream transmitted from the sending side, it refers only to the processing executed on the sending side. This document does not take into consideration the processing executed on the receiving side in a case where the transport stream normally used in digital broadcasting is used as is and transmitted at high or low rate.

Of the inventions disclosed in this application that have been accomplished to solve the above problem, the representative ones will be briefly outline as follows.

When, for example, a transport stream having video and audio packets is transmitted in broadcast waves at a high or low transmission rate different from the normal playback rate, a receiver that receives, stores and plays back the transport stream generates a timestamp representing a playback timing for the playback of the transport stream at the normal rate, by using time information representing the time when a plurality of packets in the received transport stream arrived at the receiver, time information indicating a playback timing that is recorded in each of predetermined packets periodically inserted in the same transport stream, and time information representing the time when the predetermined packets arrived at the receiver. The receiver then attaches the generated timestamps to the packets making up the transport stream and stores them.

The above outlined technique allows for easy playback of the transport stream that is downloaded, for example, at a high or low transmission rate different from a bit rate used during the normal playback of content.

Other objects, features and advantages of the invention will become apparent from the following description of the embodiments of the invention taken in conjunction with the accompanying drawings.

### BRIEF DESCRIPTION OF THE DRAWINGS

FIG. 1 is a block diagram showing an example configuration of a download type broadcast receiver.

FIGS. 2A to 2C are configuration diagrams of a transport stream used in the explanation of embodiment 1.

FIG. 3 is a diagram showing an example method of calculating a timestamp attached to transport stream packets in embodiment 1.

FIG. 4 is a flow chart showing an example operation of a download type broadcast receiver in embodiment 2.

FIG. 5 is a block diagram showing an example configuration of the receiver of embodiment 1.

### DETAILED DESCRIPTION OF THE INVENTION

Preferred embodiments of this invention will be explained in the following.

### Embodiment 1

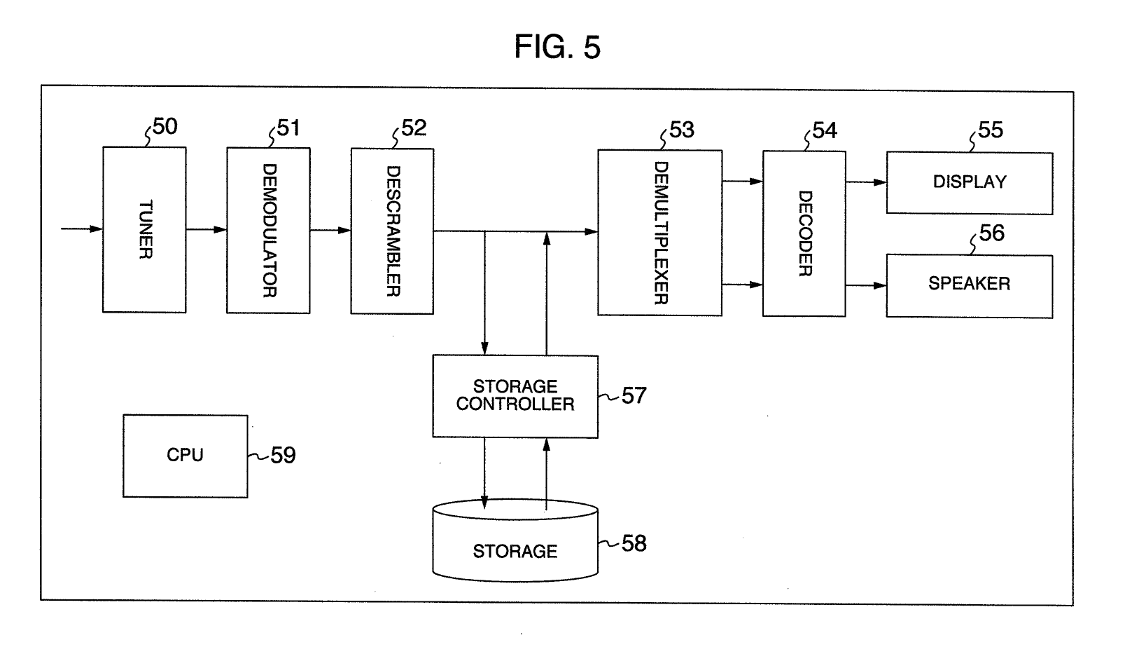

First, a basic concept of the receiver of embodiment 1 is explained. FIG. 5 shows a configuration of the receiver contemplated in this embodiment.

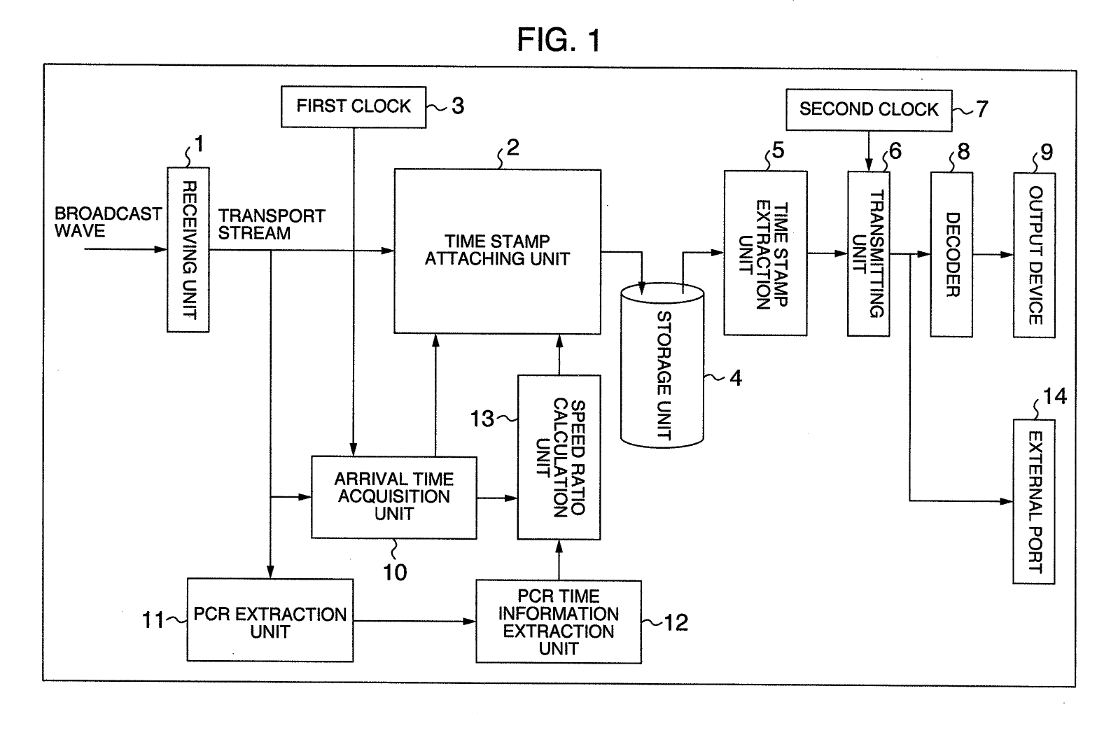

A broadcast signal is entered into a tuner 50, transformed into a transport stream by a demodulator 51 and decrypted by a descrambler 52. In the process of storing the stream, a storage controller 57 performs processing such as attaching a timestamp to the stream and records the time-stamped stream in a storage 58. During playback, a signal extracted from the storage 58 is transformed into a normal transport stream by the storage controller 57, which is then entered through a demultiplexer 53 into a video/audio decoder 54 where it is decoded, before being output to a display 55 and a speaker 56 as video and audio. CPU 59, though shown not to be wired to the respective blocks for simplicity, is actually connected to these blocks for their control. FIG. 1 is a block diagram showing functions required of the receiver in embodiment 1.

The receiver has a receiving unit 1, a timestamp attaching unit 2, a first clock 3, a storage unit 4, a timestamp extraction unit 5, a transmitting unit 6, a second clock 7, a decoder 8, an output device 9 and an external port 14.

Here, the receiving unit 1 of FIG. 1 corresponds to the tuner 50 and the demodulator 51 of FIG. 5; and the output device 9 corresponds to the display 55 and the speaker 56 of FIG. 5. They are individually constructed of hardware or integrated as one chip. An arrival time determination unit 10, a PCR extraction unit 11, a PCR time information extraction unit 12, a transmission rate ratio calculation unit 13, the timestamp extraction unit 5, the transmitting unit 6 and the first clock 3 and second clock 7 all correspond to the storage controller 57 of FIG. 5. They may also be constructed individually of hardware or integrated as one chip. The storage unit 4 may be constructed of hardware such as hard disk drive (HDD).

A function to attach a timestamp is represented by the arrival time determination unit 10, the PCR extraction unit 11, the PCR time information extraction unit 12 and the transmission rate ratio calculation unit 13.

Where a transport stream representing video and audio data is transmitted in broadcast waves at a rate different from a normal playback rate, for example, at a higher-than-normal rate, the embodiment 1 represents a device that, after receiving the transport stream, can store it in the storage unit and, for playback, read it out from the storage unit and play it back at the normal rate.

An example of services that can use this device may involve making available to a user a time table showing movie titles and their start times that can be downloaded at high speed and allowing the user to book a desired title so that the chosen movie can be downloaded in about ½ to ⅕ the normal time. Then the user can at any desired time play back the downloaded movie at the normal speed.

An overall operation will be explained as follows. A broadcast wave carrying, faster than normal, a transport stream comprised of video and audio data is entered into the receiving unit 1 consisting of the tuner and demodulator, which outputs a faster-than-normal transport stream.

The transport stream multiplexes the video and audio data in the form of transport stream packets. The transport stream has recorded in predetermined packets PCR (Program Clock Reference) time information which is representing a playback timing for normal rate playback.

The PCR is periodically arranged in the transport stream so that, when it is transmitted at normal playback rate, at least one PCR normally exists in an interval of 100 ms. The time information representing the playback timing is recorded as a count value of reference clock having a high-precision frequency of 27 MHz.

The transport stream that was transmitted at higher-than-normal speed is entered into the timestamp attaching unit 2 where transport stream packets making up the transport stream are each given a timestamp representing a playback timing for the normal playback, before being stored in the storage unit 4.

At this time, the first reference clock 3 is driven at 27 MHz, the reference frequency during the normal playback, which differs from the speed of the time information of PCR recorded in the transport stream that was received at high speed.

The content playback process involves reading out the time-stamped transport stream that was temporarily stored in the storage unit 4, comparing the time information of the timestamp extracted by the timestamp extraction unit 5 and a count value of the second clock 7 driven at 27 MHz, sending the transport stream from the transmitting unit 6 to the decoder 8 at the normal playback rate according to a result of the comparison, and outputting the transport stream from the output device 9 as video and audio.

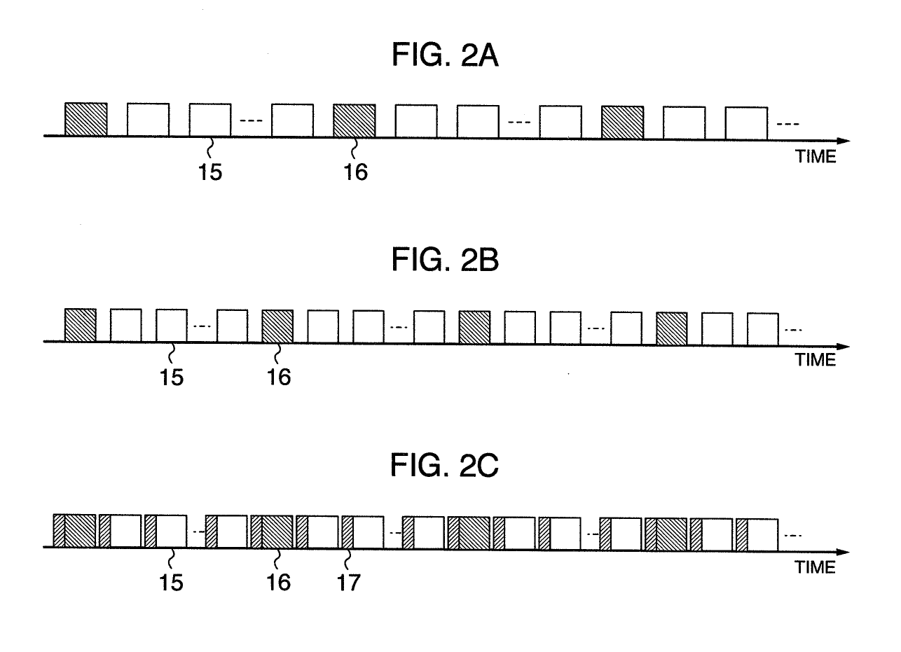

FIGS. 2A-2C show a configuration of the transport stream used in embodiment 1.

FIG. 2A shows a transport stream when transmitted at the normal playback rate, indicating that the transport stream packets 15 are transmitted along time axis and that a PCR packet 16, a predetermined packet recorded with PCR, is arranged periodically.

FIG. 2B shows a transport stream when transmitted at a higher-than-normal speed, indicating that the packets are transmitted along the time axis at a speed faster than the normal speed of FIG. 2A.

FIG. 2C shows a time-stamped transport stream, in which a timestamp 17 is added to each packet of the transport stream of FIG. 2B. The time-stamped transport stream is stored as is in the storage unit.

Next, an operation of adding a timestamp will be explained by referring to FIG. 1. The timestamp attaching unit 2 is required to add a timestamp, that can be used during the normal playback, to each packet of the transport stream received from the receiving unit 1 at a speed different from the normal playback rate, for example at a faster-than-normal speed.

The transport stream output from the receiving unit 1 comprises transport stream packets, of which predetermined ones are recorded with PCR time information.

The arrival time acquisition unit 10 gives each of the transport stream packets a count value of the first clock 3 when the packet arrived.

If the packet contains PCR time information, it is detected by the PCR extraction unit 11. Then the PCR time information extraction unit 12 extracts the time information recorded in PCR which is a count value of the 27-MHz reference clock attached to the packet when the data is encoded.

Here, a first PCR packet having first PCR information and a second PCR packet having second PCR information following the first are received. The transmission rate ratio calculation unit 13 compares a difference between two PCR times which are time information during the normal playback and a difference between two arrival times of the same PCR packets received at high speed, to calculate a ratio of the actual transmission rate to the normal playback rate.

For each packet of the transport stream, the time information which the packet should have during the normal playback can be calculated by the timestamp attaching unit 2 as follows. An increment, that changes every packet, of the count value representing the packet arrival time retrieved by the arrival time acquisition unit 10 is multiplied by the speed ratio calculated by the transmission rate ratio calculation unit 13 from the immediately preceding two PCR packets to obtain a product as a new increment. This new increment is added to a timestamp value of the immediately preceding packet to determine the time information that each packet should have during the normal playback. The time information is added as a timestamp to the transport stream which is then output as the time-stamped transport stream and stored in the storage unit 4.

As described above, the transport stream that was transmitted at a speed different from the normal playback rate can be attached with a timestamp that can be used during the normal playback.

The above process as applied to one example is detailed as follows.

(1) The arrival times of two PCR packets are obtained to calculate an arrival time difference (example: 100).

(2) PCR value recorded in each PCR packet is retrieved to calculate a difference (example: 200).

(3) The PCR value difference is divided by the arrival time difference to calculate a speed ratio (example: 2.0).

(4) Increments in arrival time of subsequent transport packets are obtained (example: 10).

(5) The arrival time increment is multiplied by the speed ratio to calculate an increment in timestamp value (example: 20).

(6) The increment is added to the timestamp value of the preceding packet to calculate a timestamp value of the current packet.

(7) The calculated timestamp is attached to the packet before storing it in the storage unit.

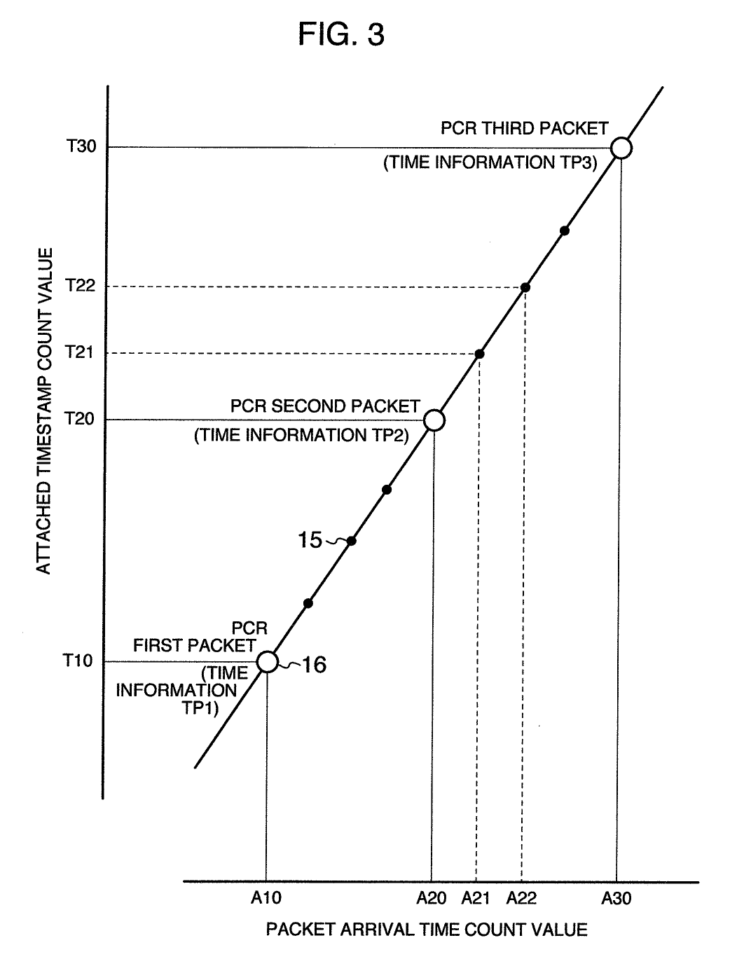

FIG. 3 shows a method of calculating a timestamp in embodiment 1. On an inclined line in the figure, transport stream packets 15 are shown as dots and PCR packets 16 among them are PCR first packet to PCR third packet.

An abscissa represents an arrival time of each packet of the transport stream including PCR packets by a count value of the first clock 3 of FIG. 1. An ordinate represents a timestamp count value indicating time information at the normal playback rate that should be attached to the individual transport stream packets.

From the arrival times A10 and A20 of the PCR first packet and PCR second packet and from the time information TP1 and TP2 recorded in the PCR first packet and PCR second packet, the actual transmission rate ratio M is expressed as follows. The equation shown below represents a case where the count values have no carry.

$$M = \frac{TP 2 - TP 1}{A 20 - A 10}$$

In attaching a timestamp to each of the transport stream packets from PCR second packet to PCR third packet by using this speed ratio M, a value of the timestamp for an example case of T22 can be given as follows, by using the value T21 of the immediately preceding packet.

T22=T21+(A22−A21)×M

### Embodiment 2

Next, a second embodiment will be explained. As described above, the timestamp value on the ordinate in FIG. 3 is calculated from the packet arrival time on the abscissa and the speed ratio M determined from the immediately preceding two PCR's. There is, however, a possibility of errors being accumulated due to repetition of calculations, changes in transmission rate, and deviations of clocks referenced on the sending side and receiving side.

When, for example, PCR second packet has arrived, T20 as the timestamp value is calculated. There is a possibility that the calculated timestamp T20 may deviate from the time information TP2 recorded in the PCR second packet, which is the true time information for this packet during playback. In that case, T20 may be replaced with the value of TP2 to correct the error.

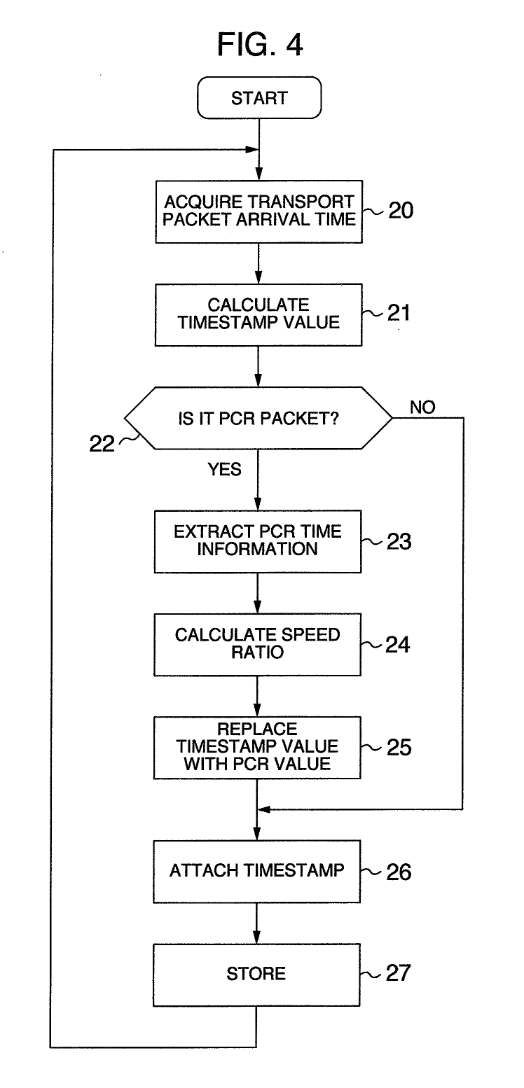

FIG. 4 is a flow chart showing an operation of embodiment 2. When a transport stream is entered, arrival time information of the transport stream packets is acquired (step 20). As explained in embodiment 1, a timestamp value to be attached to the packet is calculated from the arrival time information and the speed ratio that is already determined (step 21).

Next, a check is made as to whether the packet is PCR packet or not (step 22). If not, the calculated timestamp is attached to the packet (step 26) before storing it in the storage unit (step 27).

If the current packet is PCR packet, the PCR time information recorded in the packet is extracted (step 23). A speed ratio is calculated from the immediately preceding PCR time information and the arrival time information of the current PCR packet (step 24).

Next, the PCR time information extracted at step 23 is used in place of the timestamp value calculated at step 21 as the timestamp value to be attached to the PCR packet (step 25). The timestamp based on the PCR time information is then attached to the PCR packet (step 26) before storing it (step 27).

As described above, by correcting the timestamp to the value recorded in PCR each time a PCR packet arrives, the packets can be given timestamps before being stored while minimizing errors for a long period of time.

The object of correction may also be achieved by replacing the calculated timestamp value only when the error between the calculated value of the timestamp and the PCR time information is greater than a predetermined value.

### Embodiment 3

The preceding embodiment 1 has described an example case in which a transport stream that is transmitted over a broadcast wave is received as by a tuner 50. It is apparent that the similar effect can also be produced if, unlike embodiment 1, the transport stream is transmitted and received through communication lines such as the Internet at a speed different from the normal playback rate. In this case, the receiver is provided with a unit for receiving a communication line.

Further, in FIG. 1, it is apparent that the similar effect can also be produced if, during playback of data stored in the storage unit 4, the data as a content stream is sent at the normal playback rate from the transmitting unit 6 to other devices through the external port 14, rather than converting the data by the decoder 8 into video and audio and outputting them to the output device 9.

These embodiments may be said to be characterized in that they comprise a tuner to receive a transport stream made up of a plurality of packets; a demodulator to demodulate the transport stream received through the tuner; a storage to store the transport stream demodulated by the demodulator; and a storage controller to control data recording in the storage; wherein, when the transport stream is received at a second transmission rate different from a first transmission rate representing the normal playback rate of the packets, the storage controller adds a timestamp, which represents a playback timing for playback at the first transmission rate, to each of the packets making up the received transport stream according to time information at which the packets were received, time information representing a playback timing and contained in predetermined packets in the transport stream and arrival time information of the predetermined packets.

The above embodiments are applicable to providing a receiver that can download a content stream at a transmission rate different from a bit rate of normal playback and which can easily play back the transport stream of the temporarily stored content at the normal bit rate according to the timestamps attached to the transport stream. The embodiments can also be applied to improving the ease of use of the content download services.

It should be further understood by those skilled in the art that although the foregoing description has been made on embodiments of the invention, the invention is not limited thereto and various changes and modifications may be made without departing from the spirit of the invention and the scope of the appended claims.

1. A receiver comprising:
a tuner to receive a transport stream made up of a plurality of packets;
a demodulator to demodulate the transport stream received by the tuner;
a storage to record the transport stream demodulated by the demodulator; and
a storage controller to control the storage in such a way that, when the transport stream is received at a second transmission rate different from a first transmission rate representing a normal playback rate of the packets, each of the packets making up the received transport stream is attached, before being stored, with a timestamp representing a playback timing for playback at the first transmission rate, according to time information at which the packets were received, time information representing a playback timing and contained in predetermined packets of the transport stream and arrival time information of the predetermined packets.

2. A receiver according to claim 1, further including:
a demultiplexer to separate every predetermined packet from the transport stream demodulated by the demodulator;
a decoder to decode the predetermined packets separated by the demultiplexer using the timestamps; and
an output unit to output the packets decoded by the decoder at the first transmission rate.

3. A receiver according to claim 1, wherein the storage controller calculates a speed ratio by using PCR information contained in the predetermined packets of the transport stream and the arrival time information at which the predetermined packets arrived at the receiver; wherein the storage controller uses the speed ratio to determine a timestamp value.

4. A receiver according to claim 3, wherein the storage controller calculates the speed ratio by using a first difference representing a difference between first PCR information and second PCR information and a second difference representing a difference between first arrival time information and second arrival time information.

5. A receiver according to claim 1, receiving the transport stream via communication networks.

6. A receiver according to claim 1, further including an external port from which the stored data is transmitted at the first transmission rate to other devices via network

7. A receiver having a receiving unit to receive a transport stream made up of a plurality of packets of video and audio data forming a content, and a storage unit to record data of the transport stream; the receiver being capable of receiving the transport stream from a broadcast wave at a second transmission rate, different from a first transmission rate used to play back the content at a normal bit rate, and of extracting and storing packet data making up the transport stream;
wherein, according to time information at which the packets of the transport stream arrived at the receiver, time information periodically inserted in the transport stream and representing a playback timing recorded in a plurality of predetermined packets and arrival time information of the plurality of predetermined packets, each of the packets making up the received transport stream is attached with a timestamp representing a playback timing for playback at the first transmission rate and is stored as a time-stamped packet.

8. A receiver according to claim 7, adapted to generate time information of timestamps for packets of the transport stream by using:
time information periodically inserted in the transport stream and representing a playback timing recorded in one of the predetermined packets or current predetermined packet,
time information at which the current predetermined packet arrived at the receiver,
a ratio of a first transmission rate and a second transmission rate determined from time information recorded in a predetermined packet immediately preceding the current predetermined packet of interest and from time information at which the immediately preceding predetermined packet arrived at the receiver, and
arrival time information of each packet of the transport stream.

9. A receiver according to claim 8, wherein, when the predetermined packet periodically inserted in the transport stream has arrived, an error of the time information of the timestamp, which was calculated from the time information representing a playback timing recorded in the predetermined packets, is corrected.

10. A receiver according to claim 7, further including a network receiving unit to receive the transport stream from a communication network.

11. A receiver according to claim 7, further including a playback unit to play back the stored content as video or audio at the first transmission rate.

12. A receiver according to claim 7, further including an external port from which the stored content data is transmitted to other devices through a network at the first transmission rate.

13. An information processing method when a transport stream made up of a plurality of packets is received at a second transmission rate different from a first transmission rate representing a normal playback rate, the information processing method comprising the steps of:
demodulating the received transport stream;
attaching a timestamp, which represents a playback timing for playback at the first transmission rate, to each of the packets making up the received transport stream, according to time information at which the packets were received, time information representing a playback timing and contained in predetermined packets of the transport stream and arrival time information of the predetermined packets; and
storing the time-stamped packets.

14. An information processing method according to claim 13, wherein the stored transport stream is played back at the first transmission rate.

15. An information processing method according to claim 13, further including the steps of:
calculating a speed ratio by using PCR information contained in predetermined packets of the transport stream and arrival time information at which the predetermined packets arrived at the receiver; and
determining a timestamp value by using the speed ratio.

16. An information processing method according to claim 15, further including the steps of:
calculating the speed ratio by using a first difference representing a difference between first PCR information and second PCR information and a second difference representing a difference between first arrival time information and second arrival time information.
